(19) United States
(12) Patent Application Publication
(10) Pub. No.: US 2003/0097420 A1
(43) Pub. Date: May 22, 2003

(54) Multi-channel delivery system

(76) Inventors: Mandar Chitre, Singapore (SG); Ng Yew Choong, Singapore (SG); Shehan Warusavithana, Singapore (SG)

Correspondence Address: Bradley W. Crawford, McDonnell Boehnen Hulbert & Berghoff, 32nd Floor, 300 S. Wacker Drive, Chicago, IL, 60606, US

(21) Appl. No.: 10/138,960

(22) Filed: May 3, 2002

(30) Foreign Application Priority Data
May 5, 2001 (SG) 200102927-1

(51) Int. Cl. G06F 15/16

(52) U.S. Cl. 709/217; 709/246

(57) ABSTRACT

A design methodology for multi-channel delivery of digital data; the methodology including the step of defining a plurality of reusable guide components; at least some of the components adapted to guide the presentation of a predefined set of data groupings; the data groupings common to more than one digital interface device operating on one or more channels.

The present invention relates to a system and components for multi-channel delivery of information in the form of digital data.

### BACKGROUND

Life today relies on access to information easily and quickly. This is not only critical in the financial industry but also in other businesses and in leisure. An investor may be interested in instant access to his stock price information, a businessman may be interested in news, a salesman may be interested in inventory information, and a young couple may be interested in what movies are showing in town currently. More and more ways of getting access to such information are becoming popular.

In the 1980s, print media, mail and telephone were probably the most important channels of information delivery. In the mid-1990s, Internet access from desktop PCs (i.e. e-mail and the Web) gained importance. In the past few years, new access points like Kiosks, mobile phones and handheld computing devices (PDAS) have gained popularity. In the next few years, it is likely that we will see an exponential growth in the access points available with in-car stereo systems, in-flight entertainment systems, game consoles, interactive TVs and white goods becoming information delivery capable.

Each person is likely to use a combination of these channels in his or her daily life, perhaps a desktop PC connected to the Internet at work, a mobile phone or a PDA on the move, an in-car stereo system while driving and maybe a interactive TV set at home. He would expect the same set of services available to him from the different access points. However, he would expect the services to take advantage of the special features of each access point when possible. This is what we term as multi-channel delivery.

Any service (or content) provider who wants to cater to a host of different access points faces a major problem. Firstly, developing the service individually for each of the access points requires a large amount of effort. Even if the service provider was willing to put in that investment, maintenance of such a system is extremely expensive as each modification to the system needs to be replicated on all the access points.

With reference to FIGS. 1 And 2 there is shown in diagrammatic form respective first and second prior art methods for delivery of essentially the same information (stored in digital form) to a first access joint in the form of a PC-based web browser and a second access point in the form of a WAP-enabled mobile phone.

In each instance there is a body of information represented in digital form on an application/database server with the web browser representing a first channel of access to that information and the WAP-enabled mobile phone representing a second channel to that information.

Different data delivery mediums and different access devices together dictate, often, both how much of and in what fort the same information on the application/database server should be presented.

Typically the information is initially reduced to a digital form specifically for and with one particular communication medium and one particular access device in mind.

The challenge is how to make this same body of information available, at the one time, to a multiplicity of access devices communicating over a multiplicity of communication mediums. Broadly this issue is referred, to as “multi-channel delivery” of information.

To date there have been three primary approaches to this multi-channel delivery problem, each of which might be termed “a brute force” method. The three prior art approaches are (1) automated transcoders, (2) rule-based transcoding and (3) separating the business logic and the presentation logic and recoding the presentation logic for every access point/device and communication medium. These three approaches are described in more detail below and with reference to FIG. 1 and FIG. 2:

The easiest approach to multi-channel delivery is the use of automated transcoders. An automated transcoder acts as a proxy and helps transcode the requests and the content between the service provider and the access point. The transcoder adapts to the access point and therefore the application at the service provider does not have to be aware of the different access points. At first glance, this seems like an excellent solution, but anyone with experience trying to build a system using this approach knows it's shortcomings. Presentation designed for different access points is significantly different. It's not just the format of the presentation, but rather the information architecture or application flow that needs to be different on different access points. An automated transcoder cannot cater to different information architectures for different access points.

The second approach is called rule-based transcoding. A rule-based transcoder has a set of rules for every page that is transcoded. This allows it to implement very different presentations, including slightly different information architectures. However, a rule for every access point for every page implies not only a large initial effort to set up the rules, but also a large maintenance effort to change the rules every time a page is updated.

The third approach involves separating the business logic and the presentation logic, and re-coding the presentation logic for every access point. Although very flexible, the effort requirement in creation and maintenance of these presentations is similar, if not more, than the rule-based transcoding approach.

It is an object of the present invention to address the multi-channel delivery problem in a more sophisticated and more flexible manner or at least provide a useful alternative.

It is a further object of at least preferred embodiments of the present invention to provide a multi-channel delivery system which is scalable. As used here “scalable” refers to the performance of the system as the number and type of access points and delivery mediums increases.

### BRIEF DESCRIPTION OF INVENTION

Accordingly, in one broad form of the invention there is provided a design methodology for multi-channel delivery of digital data; said methodology including the step of defining a plurality of reusable guide components; at least some of said components adapted to guide the presentation of a predefined set of data groupings; said data groupings common to more than one digital interface device operating on one or more channels.

Preferably the number of reusable guide components is minimized.

In yet a further broad form of the invention there is provided a reusable guide component for multi-channel delivery of digital data; said reusable guide component adapted to guide the presentation of a predefined data grouping which is common to more than one digital interface device operating on one or more channels.

Preferably said digital data comprises presentation logic data.

In yet a further broad form of the invention there is provided an environment for implementation of reusable guide components for multi-channel delivery of digital data; said reusable guide components operable in said environment to adapt information segments requested for instantiation on a predefined set of digital interface devices operating on a predefined set of channels whereby said information segments are converted to customized digital data adapted for direct execution on a specified one of said digital interface devices.

Preferably said environment includes one or more functional sub-systems selected from:

(a) A reusable guide component system

(b) A dynamic XML conversion system

(c) A modified mark-up language overlay system

(d) An automatic fragmentation system

(e) A device-aware presentation control system.

In yet a further broad form of the invention there is provided a modified mark-up language for use as an overlay to a mark-up language representing data including presentation logic data for display on a broadly defined class of digital interface devices operable over a predefined set of channels; said modified mark-up language including tags which define commands for interpretation of said presentation logic data.

Preferably said tags provide a mechanism for controlling how a subset of said presentation logic data is to be presented on said interface device.

In yet a further broad form of the invention there is provided a mechanism for dynamic conversion of serializable Java objects into XML, said mechanism performing XML conversion by overriding the toString ( ) method of a Java object.

In yet a further broad form of the invention there is provided a method of processing presentation logic data comprising processing an information segments from which said presentation logic data is to be derived whereby said presentation logic data is segmented into sub-components of lower complexity and whose output can be re-purposed for different ones of a predefined set of digital interface devices operating over a predefined set of channels.

### BRIEF DESCRIPTION OF DRAWINGS

Embodiments of the present invention will now be described wherein:

FIG. 1 is a diagrammatic representation of a prior art approach to multi-channel delivery of information utilizing a transcoder;

FIG. 2 is a diagrammatic representation of an alternative prior art approach to multi-channel delivery of information comprising separation of business logic and presentation logic;

FIG. 3 is a block diagram of a multi-channel delivery system in accordance with a first generalized embodiment of the present invention;

FIG. 4 is a block diagram of the application of the system of FIG. 3 to two specific digital interface devices;

FIG. 5 provides a specific example of the process of definition of specific reusable guide components common to a plurality of data groupings of the type defined with reference to FIG. 3;

FIG. 6 is a block diagram of implementation of the system of the present invention in accordance with a further preferred embodiment;

FIG. 7 is a block diagram of an architecture suitable to implement embodiments of the system of FIG. 3;

FIG. 8 is a flowchart of operation of an environment applicable to the system of FIG. 7.

FIG. 9 is a block diagram of an implementation of the system of the present invention as a thin-client model and with reference to and incorporation of the content of Appendix A.

### DETAILED DESCRIPTION OF PREFERRED EMBODIMENTS

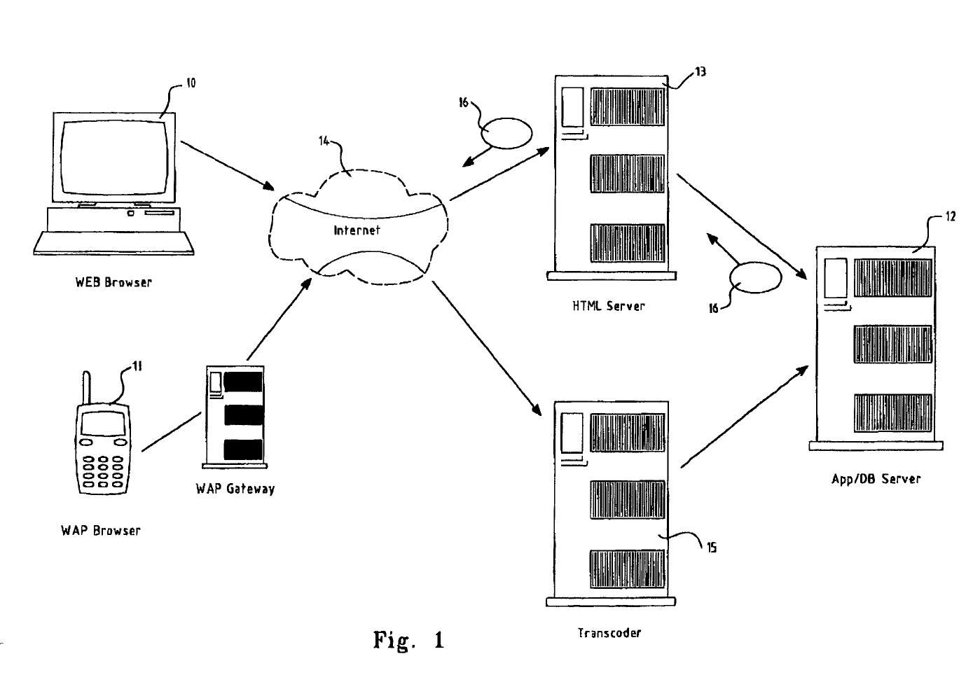

With initial reference to FIGS. 1, 2 and 3 the following definitions apply in this specification:

A “digital interface device, is a device which permits a user to at least receive and usually, also send, digital information. Examples include PC based web browsers and WAP-enabled mobile telephones, which have also been referred to in this specification as “access points”.

A “communications medium” is a medium for the communication of digital data between a digital interface device and a separate information store containing digital data. Typical communications mediums today include computer networks, telephone networks and radio networks. Typically the medium is electronic in nature, although other mediums are contemplated including, for example, optical and electro-optical mediums.

A “channel” or “communications channel” comprises a specific communications medium operating in conjunction with either a specific digital interface device or a specific class of digital interface devices. The current worldwide interconnection of computers and servers known as the “Internet” in conjunction with the class of digital interface devices known as web browsers is an example of a channel. Another example of a channel is the use of a radio network in conjunction with the class of devices currently known as WAP-enabled mobile or cellular telephones.

Typically, these days, communication of digital data to and from digital interface devices takes place by way of the transmission and reception of predefined groupings of digital data which, in this specification, are termed “information segments”. A typical information segment is a single web page as it appears on a PC-based web browser. Information segments can comprise business logic data, presentation logic data or combinations of the two.

In this specification “business logic” data the standard J2EE provides meanings for and the concept of separation of “business logic” and “presentation logic”. More generally, and as to be understood in this specification, “presentation logic” data is that data which is directly related to and results in output on a digital interface device which can be interpreted visually by a user. “Business logic” data refers generally to data destined for request by and/or execution on a digital interface device 23, 28 and can include applications data such as executable programs and data structures which may themselves become part of presentation logic data or which may give a guide to the interpretation of presentation logic data.

As discussed in the background section of this specification and with reference to FIG. 1, one prior art approach to multi-channel delivery to for example a first digital interface device in the form of a web browser 10 and to a second digital interface device in the form of a cellular telephone enabled as a WAP browser 11 in respect of information segments to be obtained from application/database server 12 and on the assumption that the information segment requested has been written, initially, suitable for delivery by HTML server 13 to web browser 10 via a communications medium in the form of Internet 14 has been to utilize a transcoder 15 to interpret the information segment into a form suitable for use by WAP browser 11. The transcoder 15 can operate either as an automated transcoder as previously described in the introduction or, alternatively, as a rule-based transcoder also as described in the introduction.

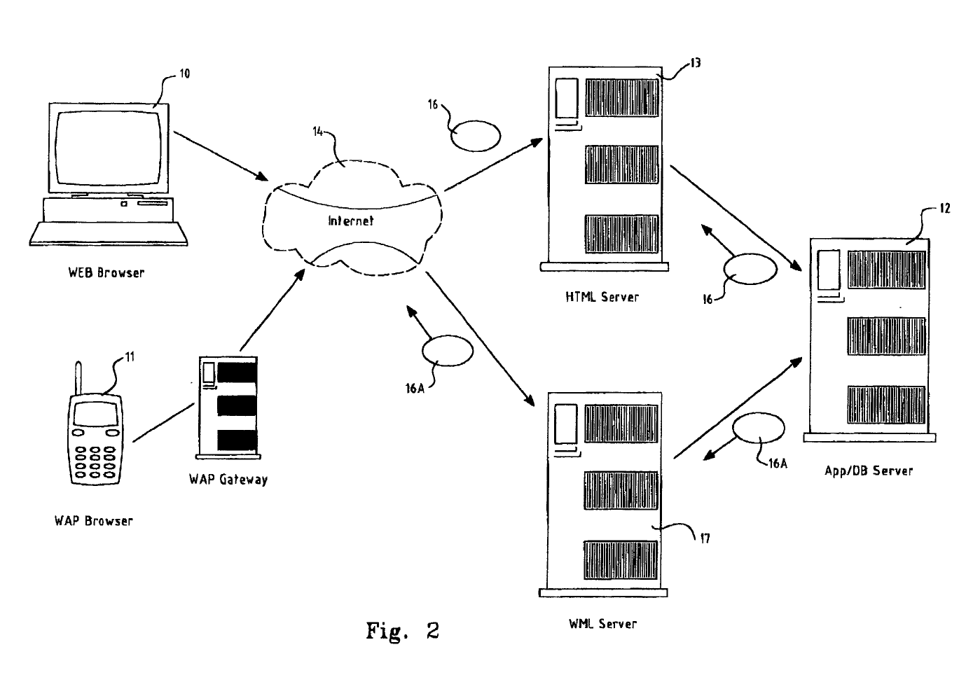

With reference to FIG. 2 wherein like components are numbered as for FIG. 1 the approach here is to have information segment 16 available both in a form suitable for ITML server 13 and also in a separate (re-written form) suitable for WML server 17 the re-written information segment is designated 16A.

These “brute force” approaches are found wanting as the system is scaled which is to say as the number of different digital interface devices and communication mediums increases.

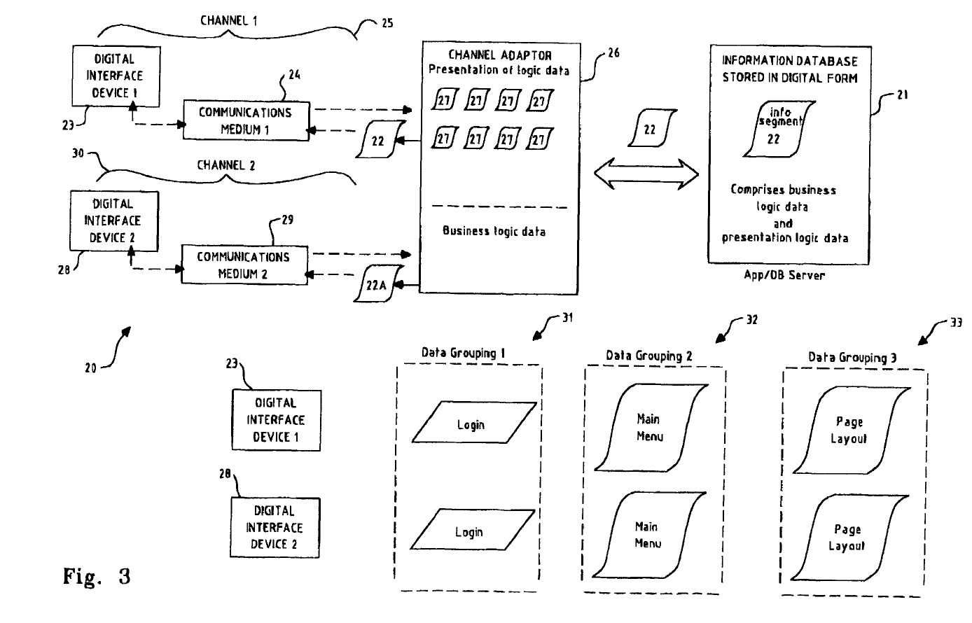

With initial reference to FIG. 3 a multi-channel delivery system 20 according to a first generalized embodiment of the present invention will now be described. In this instance the system 20 will be described with reference to only two digital interface devices, but it will be understood that the system can be scaled significantly to accommodate a wide variety of digital interface devices operating over a wide variety of channels.

In this instance system 20 comprises an information database 21 having stored therein in digital form a plurality of information segments 22.

If a user of first digital interface device 23 communicating over first communications medium 24 and comprising first channel 25 desires to access information segment 22, the user (not shown) operates first digital interface device 23 so as to make the appropriate request. The request is passed via channel adapter 26 to information database 21 wherein information segment 22 is accessed and communicated to channel adapter 26 wherein a plurality of re-usable guide components are utilized so as to convert dynamically information segment 22 into customized information segment 22A suited for direct utilization by first digital interface device 23 on first channel 25.

In similar manner, should a second user (not shown) operating second digital interface device 28 desire to access the same information segment 22 the user will operate second digital interface device 28 so as to communicate the request for information segment 22 via second communications medium 29 (and forming part of second channel 30) via channel adapter 26 to information database 21. Information segment 22 is then communicated to channel adapter 26 for processing in conjunction with and with reference to the same set of reusable guide components 27 thereby to convert information segment 22 into channel customized information segment 22B suited for direct execution on second digital interface device 28.

With further reference to FIG. 3 the information segment 22 typically comprises digital data which can be grouped, in this instance, into first data grouping 31, second data grouping 32 and third data grouping 33. Broadly and functionally each data grouping 31, 32, 33 will have been initially written and stored with a view to providing the same functional end result irrespective of the digital interface device to which the information segment 22 is downloaded. So, in this instance, first data grouping 31 comprises a “login” data grouping and, whether executed for display on first digital interface device 23 or second digital interface device 28 the function as viewed or interpreted by a user of each respective device 23, 28 will be that of a login function.

Similarly second data grouping 32 performs the function of “main menu” whilst third data grouping 33 provides a “page layout” designation.

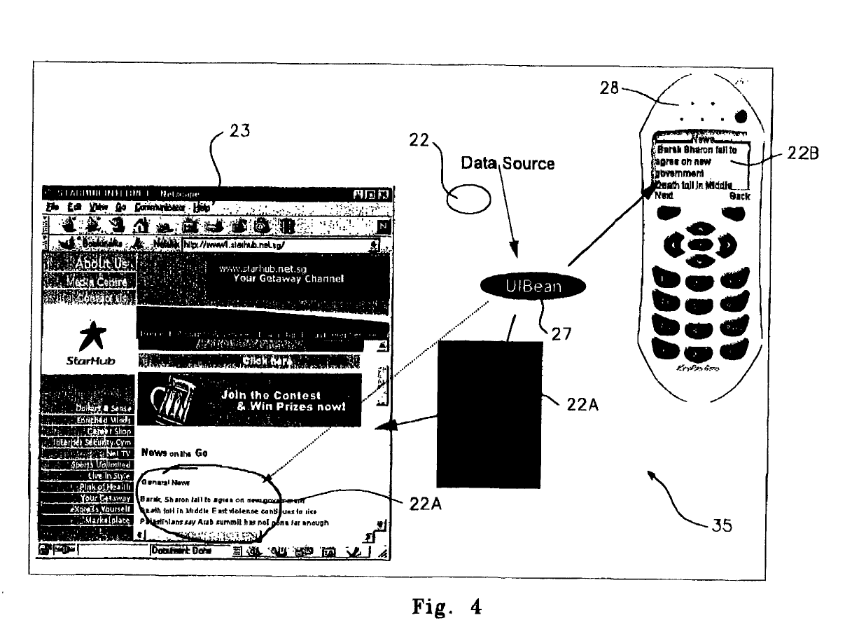

With reference to FIG. 4 there is illustrated a specific instance of the presentation of third data grouping 33 on both a first digital interface device 23 comprising, in this instance, a PC-based browser page and, in the case of the second digital interface device 28 a WAP-enabled cellular phone display. The same information segment 22 (in this instance comprising a page layout data grouping in the form of a brief news item) is acted upon in conjunction with reusable guide component 27 to produce customized information segment 22A for the PC-based browser comprising first digital interface device 23 and customized information segment 22B for second digital interface device 28 comprising the WAP-enabled cellular telephone display.

In each instance it will be noted that the data comprising information segment 22 as impacting on a user of either first digital interface device 23 or second digital interface device 28 is the same except that the information segment 22 has been customized for delivery over the respective first and second channels and presentation/execution on the respective digital interface device.

In this instance the specific example of information segment 22 relates to presentation logic data.

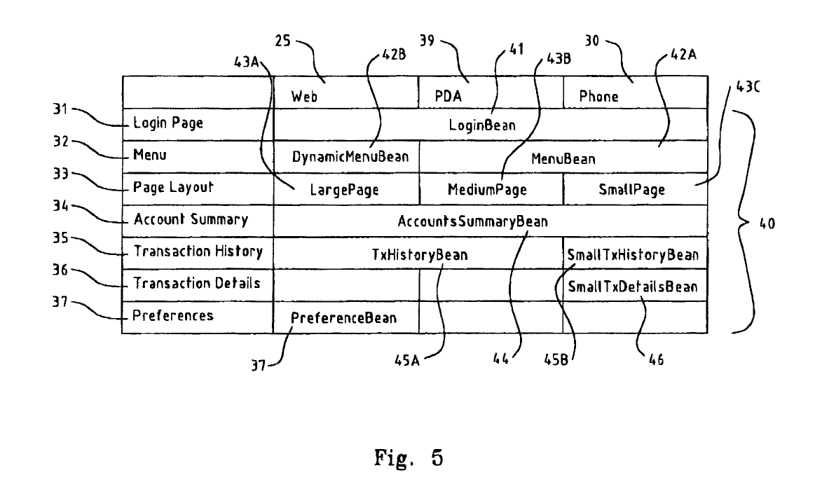

FIG. 5 presents, in tabular form, some instances of data groupings identifiable for a specified set of channels and a suitable re-usable guide component mapping.

In this instance the data grouping set comprises first data grouping 31 in the form of a “login page”, second data grouping 32 in the form of a “menu”, third data grouping 33 in the form of a “page layout”, fourth data grouping 34 in the form of an “account summary”, fifth data grouping 35 in the form of a “transaction history”, sixth data grouping 36 in the form of “transaction details” and seventh data grouping 37 in the form of “preferences”.

In this instance the channels envisaged comprise first channel 25 proposed for communication with first digital interface device 23 over first communications medium 24 (with reference to FIG. 4 a specific instance is that of a Web page communicated over the Internet). Also envisaged is second channel 30 intended for communication of digital data to second digital interface device 28 over second communications medium 29 (a specific instance is a WAP-enabled cellular telephone operating over a cellular telephone network with reference to FIG. 4). Finally a third channel 39 is envisaged comprising, in this instance, a PDA (personal digital assistant) intended to commmuicate over the Internet.

In this instance the first reusable guide component 41 is in the form of a “LoginBean” which maps directly login page 31 to all envisaged channels 25, 30, 39.

The mapping 40 further comprises second reusable guide component 42 which maps as “MenuBean” 42A to both channels 39 and 30 and “Dynamic MenuBean” 42B which maps to channel 25.

Similar reusable guide components are identified as third reusable guide component 43A, 43B, 43C, fourth reusable guide component 44, fifth reusable guide component 45A, 45B, sixth reusable guide component 46 and seventh reusable guide component 37.

As will be further described below a goal of the design of the reusable guide component mapping 40 is to minimize the number of reusable guide components required subject to optimizing output as perceived by the end user of any digital interface device operating on any of channels 25, 39, 30.

The methodology reflected in FIG. 5 for the creation of reusable guide component mapping 40 amounts to a design process presentation logic data derived from information segment 22 which seeks to break up presentation complexity into smaller components of lower complexity whose output can easily be repurposed for different digital interface devices and different channels. These components may be embedded within other components to form more complex components suitable for delivery over devices which support more complex presentation.

It should also be noted that the generalized embodiment described with reference to FIG. 3 lends itself to both thin client and tat client architectures.

For thin client architectures the channel adapter 26 and the processing of the reusable guide components 27 will take place within a server environment or associated with a server environment.

In the case of a fat client implementation the processing and execution of the reusable guide components 27 can take place in the environment of the digital interface device—that is, on or in association with the client rather than on or in association with the server.

The majority of the description which follows concentrates on a thin-client architecture by way of example only.

Similarly, in the embodiments and example to be described further below J2EE(JSP/EJB) technology on the server-side is assumed. An alternative, not further canvassed here, could include, for example, Microsoft's ASP/DNA/COM technologies on the server-side.

In the description which follows the reusable guide components 27 are implemented as and referred to as user interface beans (UIBeans) shown as Java and JSP representations. By way of alternative example the same functionality and behavior could be implemented utilizing ASP, Cold Fusion or other dynamic web presentation mechanism.

An object-oriented environment is assumed and Universal Mark-up Language (UML) is utilized to provide sufficient detail as to how to implement some of the concepts.

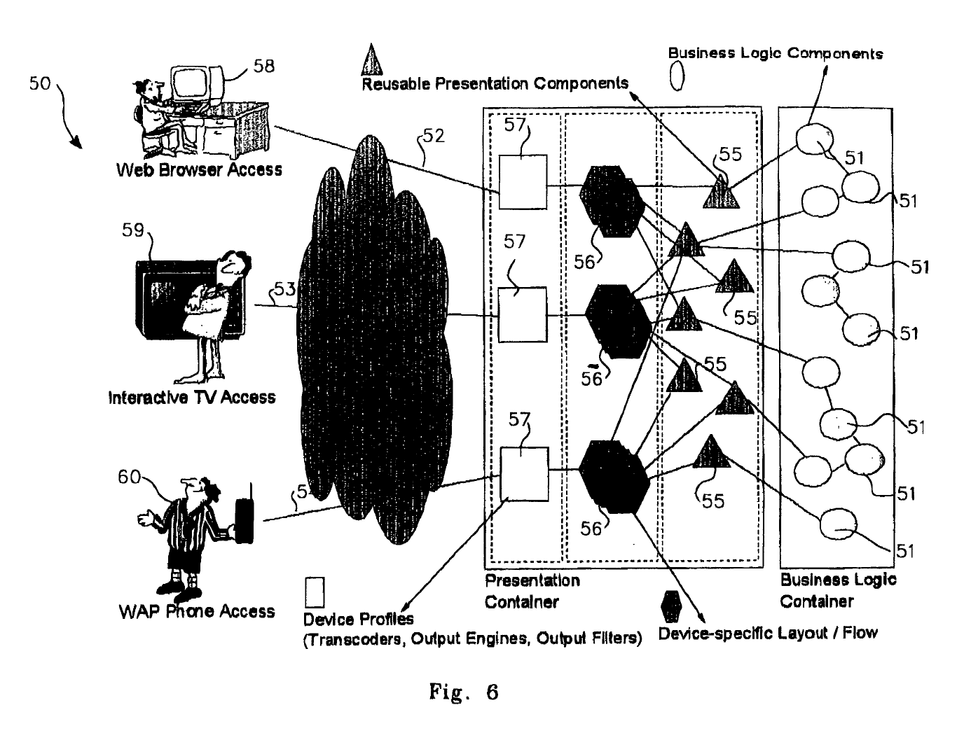

In the description which follows firstly in part A the reusable guide components 27 will be explained by way of more particular example and with reference to FIGS. 5 and 6.

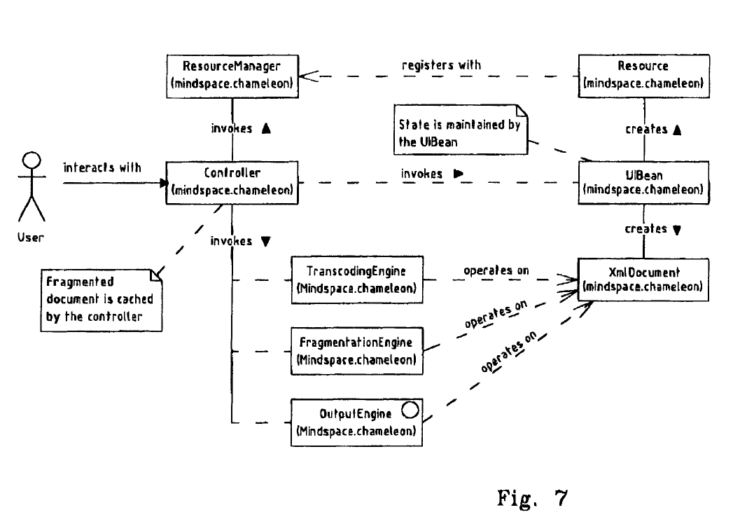

Then, in part B, and with reference to FIGS. 6 and 7 a number of sub-systems which are useful to support the re-usable guide components in an actual implementation are described.

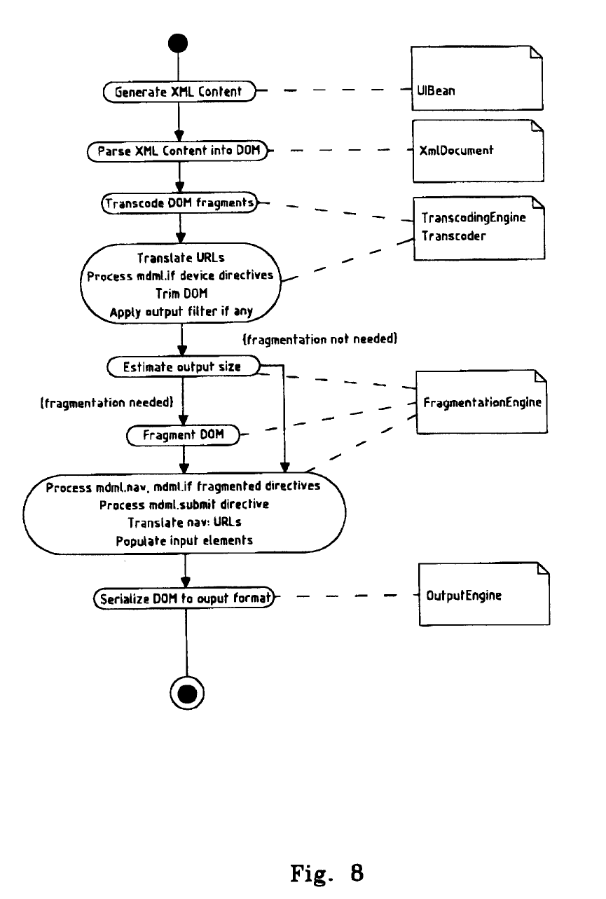

In part C and with reference to FIGS. 7 and 8 a total environment and framework for the implementation of a system which takes advantage of the reusable guide components of embodiments previously described is itself described using a Model-View-Controller (MVC) models.

Finally, by way of example 1, a specific example of an environment which implements the system of the present invention is described with reference to the environment of FIG. 7.

Following on from the generalized arrangement of FIG. 3 the arrangement, according to a further preferred embodiment of FIG. 6, illustrates broadly how a multi-channel delivery system 50 for distribution of information segments defined within a plurality of business logic components 51 can operate.

The system is arranged to allow a plurality of users operating through at least three separate pre-defined channels 52, 53, 54 can receive the information segments, each tailored for the particular channels 52, 53, 54.

Reusable presentation components 55 are illustrated as triangles. Device specific layout/flow is represented as hexagons.

Ultimately sub-systems 57 are applied to the dataflow specific to each of channels 52, 53, 54 and digital interface devices 58, 59, 60.

A. Re-Usable Guide Components—UIBean Implementation

J2EE defines the separation of business logic and presentation logic clearly, but having a web container to host the presentation and an EJB container to host the business logic. In implementation with other technologies, the separation may not be explicitly supported by the technology, but the application design that implements the system of the present invention must separate the two. However, in the system of the present invention, rather than develop different presentation layers to address different access points, we will develop a single presentation layer that can adapt to different access points.

The benefits from the system of the present invention are apparent when the number of access points is large. This is due to the fact that the bulk of the presentation logic in the system of the present invention is reusable across access points. To enable this, the system of the present invention requires the presentation to be developed as components.

Typical web designers design “pages” that are accessed from the browser. Usually a JSP represents a page. The system of the present invention requires that a page is further divided into several components which are represented independently. These components can then be combined into larger components or at the top-level, into pages. These pages are then displayed on the access point. By making the components reusable, they can be arranged in different ways on different access points. Certain components may have different implementations for different access points, but can easily be supported in this model without having to redevelop the entire page.

The reusability of components in the system of the present invention requires that minimal assumptions are made regarding the access point. A typical web application assumes that the access point is a thin-client browser, which accesses the application over a request-response client-model (such as HTTF). However, when dealing with other access points, this assumption may not hold. The system of the present invention architecture takes care of the complexity of the client-model while the application design treats the presentation components as if they are running locally on the device. This approach allows the same presentation to be deployed both on thin-client architectures (such as web, WAP etc.), fat-client architectures (such as MIDP, MHP, etc.) and even as stand-alone applications.

To support the reusable component based client-model independent design. the system of the present invention creates a new type of “bean” called a UIBean. A UIBean is a reusable component which knows what display formats it supports, how to display itself and how to respond to different events.

It is expected that the presentation of the UIBean is expressed as a XML document, which is not as restrictive as it seems as we shall see later. The events that the UIBean responds to are implemented as methods. The events may be referred from the presentation directly using special URLs that are independent of the client-model.

A UIBean can be represented as a Java object or even a JSP.

Sample Java Representation

class DemoBean extends UIBean {

public String getFormat( ) {

return “xml/html” ;

}
public void paint (Context c) {

c.out.printIn(“<html><body>”) ;
c.out.printIn(“ <a href=‘java:trigger’>Trigger</a>”) ;
c.out.printIn(“</body></html>”) ;

}
public void trigger (Context c) {

Database.log(“user has clicked on trigger”) ;

}

}

Sample JSP Representation

<%@page contentType=“xml/html”%>
<%!

public void trigger(Context c) {

Database.log(“user has clicked on trigger”) ;

}

%>
<html>

<body>

<a href=“java:trigger”>Trigger</a>

</body>

</html>

Note the ∂java:trigger” URL which refers to the Java method implementation of the trigger event. This allows for client-model independence.

It is also possible to include UIBeans inside other UIBeans. For example, a page with 3 panes represented by different UIBeans can look like:

<%@page contentType=“xml/html”%>
<%!

UIBean title, menu, context;
public void SetContents(UIBean t, UIBean m, UIBean c) {

title = t;
menu = m;
context = c;

}

%>
<html>

<body>

<table>

<tr><td colspan=“2”><% title.render(context) ; %></td></tr>
<tr>

<td><% menu.render(context) ; %></td>
<td><% content.render(content) ; %></td>

</tr>

</table>

</body>

</html>

UIBeans can be extended. Extended UIBeans inherit the events and the presentation of the parent UIBean. They can then override the presentation or the behavior, thus enhancing component reusability. Overridden methods allow for new event handlers as well as completely new presentation. However, alternate mechanisms for extending presentation such as XSLT can be supported as well.

B1. Re-Usable Guide Component Maping System

UIBeans give us the tool required for the representation of components for presentation. However, it is important that the architect designs the components such that they are reusable, It is helpful during the design phase to list down a matrix of all access points against all components and fill in the names of the UIBeans that implement the component for each access point.

The goal of the design is to reduce the number of entries in this table as much as possible without sacrificing the output required. To facilitate this, several mechanisms can be provided to the architect that lets him design the components independently of the target access points.

B2. Automatic Transcoding Sub-System

The first mechanism allows the architect to implement different UIBeans in different formats. The UIBeans may then be included within other UIBeans and eventually in a page. The access point may request a different format from any of the UlBean. The automatic transcoding engine can then apply different transcoders to the different UIBeans and create a page in the requested format for delivery to the access point.

Different transcoders can be represented as XSLTs or classes implemented by the application developer But the separation of the transcoders from the presentation allows the architect to design the presentation without worrying about formats, and then designing the transcoders such that the formats can be converted.

Although automatic transcoding does not work well on a page as a whole, as long as the presentation of each UIBean is simple, it becomes feasible to automatically transcode the UIBean. The pages for the different access points would typically be very different and composed of many smaller UIBeans.

This is best illustrated by an example. The example used in the last section shows how a page could be composed out of 3 UIBeans. This would be a typical kind of presentation for the web. On small devices such as mobile phones, the same UIBeans may be used in a sequence of pages rather than in a single page.

B3 Output Filters and Output Engines

The second mechanism helps an architect control the exact format of the content supported by a device. Output filters remove all nodes in a XML document that the device does not understand. This allows the original format to contain more information than is supported by some of the access points. For example, a UIBean intended for a web page and a mobile phone may contain color information. However, it the mobile phone does not support color, the output filter could remove the color information before delivering the output to the device.

Output engines convert the XML content into any format that is understood by the access point. For example, a web page may support HTML (which is not XML compliant) or a WAP device may support WMLC (which is a binary compressed XML representation). As the UIBean presentation requires XML for processing, in case of a web page, XHTML could be used in the application and in case of the WAP device, WML would be used. After all processing is completed, the output engine would convert the XML-compliant representation (XHTML, WML) to the format that the access point understands (HTML, WMLC). This approach allows non-XML-capable access points to be addressed using the UIBean approach.

B4 Automatic Fragmentation Sub-System

Many devices have restrictions on the size of the content they can handle. This may be due to limited memory, bandwidth or screen size. Rather than develop different UIBeans that display different amounts of information to the user, a fragmentable UIBean allows automatic fragmentation based on the target device.

Fragmentable UIBeans have special mark-up in them to identify areas in the UIBean that should be fragmented and areas that should not. It also helps identify the representation of the navigation buttons if the UIBean is fragmented.

For example, a transaction history UIBean may want a title at the top to be always present, whereas the records in between to be fragmented. Also it may want to keep all the fields in a single record together. It may want a navigation bar only if the page was fragmented. This can be represented as:

<html>

<body>

<p>Title</p><br/>
<table>

<mdml.fragment>

<% for (int i = 0; i < n; i ++) { %>
<mdml.atom>

<tr><td><%= fld1 [i] %></td><td><%= fld2 [i] %></td></tr>

</mdml.atom>
<% } %>

</mdml.fragment>

</table>
<mdml.if fragmented=“true”>

<mdml.nav type=“prev”><a href=“nav:prev”>Prev</a></mdml.nav>
<mdml.nav type=“next”><a href=“nav:next”>Next</a></mdml.nav>

<mdml.if>

</body>

</html>

B5. Device-Aware Presentation Control (MDML) Overlay Sub-System

We have already come across some MDML tags that control fragmentationn in the last section. MDML (Multi-device Markup Language) is a collection of presentation control tags that can be used with any presentation format to make the presentation device-aware. Below is a table of tags defined in MDML.

| | |
|---|---|
| <mdml.if | Conditional output based on target device. The device is |
| device = “device-name” | matched using it's name. |
| > | |
| <mdml.ouput | Delimits output fragments in different formats |
| format = “content-format” | |
| > | |
| <mdml.fragment | Delimits a section that is allowed to be fragmented. |
| break-text = “true\|false” | |
| > | |
| <mdml.atom> | Delimits a section that is not allowed to be fragmented, |
| | even if it appears inside a mdml.fragment section. |
| <mdml.if | Conditional output only if the document has been |
| fragment = “true\|false” | fragmented (or otherwise). |
| > | |
| <mdml.nav | Conditional output based on the need for navigation. |
| type = “prev\|next\|submit” | “prev” is rendered on all pages except the first “next” is |
| > | rendered on all pages except the last. “submit” is |
| | rendered only on the last page. |
| <mdml.submit | This URL is used for the submission of data from this |
| href = “url” | document. A nav:next URL is translated using this URL. |
| > | |

B6. XML Representation of Objects (XMLIZER) Sub-System

The XMLizer converts the data in a object to XML automatically. This is extremely useful when most of the data in the object needs to be presented. Rather than write a JSP that shows each field in the object, the XMLizer converts the whole object into XML. A recommended XML format for Java object representation is defined by JOX. A transcoder (possibly a XSLT) would then convert this XML representation to the format required by the target access point as part of the automated transcoding process.

With XMLizer, an object may be introduced in the JSP directly, rather than it's individual components. For example,

<html>

<body>

<%= personalDetails %>

</body>

</hmtl>
rather than
<html>

<body>

<p>Name: <%= personalDetails.getName( ) %><br/></p>
<p>Address: <%= personalDetails.getAddress( ) %><br/></p>
<p>City: <%= personalDetails.getCity( ) %><br/></p>
<p>Tel: <%= personalDetails.getPhone( ) %><br/></p>

</body>

</html>

B7. Resource Manager for Cached Resources Sub-System

On many devices, certain kinds of presentation entities cannot be represented in the XML document, but have to be referenced from it. For example, images in HTML documents are refered to be URLs specified in the “<img src= . . . >” tag. The image itself has to be available separately.

To cater for UIBeans which need presentation that requires references Resources, the system of the present invention introduces the concept of a Resource Manager. A UIBean (or any other presentation component including transcoders) may create a Resource and register it with the Resource Manager. When the target access point requests this resource, the Resource Manager provides this cached Resource without having to invoke the UIBean again.

This can be very useful when dynamic images or other media type need to be generated in the presentation.

C. Environment and Framework for Implementation

Having designed an application using the system of the present invention approach, we need an architecture to run the application. A suitable architecture for implementing such an application is shown in FIG. 7.

The architecture uses an MVC (Model-View-Controller) model where a controller manages all access to the application. The controller invokes the necessary UIBeans followed by the transcoding engine, output filters, fragmentation engine and output engine. The controller manages the caching and navigation of fragmented documents and the application developer only has to develop the UIBeans.

The UIBeans, although not shown in FIG. 7, may interact with other UIBeans, presentation classes and business logic beans (EJBs) to create their output. To illustate the process more clearly, the steps needed in the controller process are shown in FIG. 8.

### EXAMPLE 1

Introduction

The example environment of FIG. 7 implements the system of the present invention architecture. It provides a framework to run applications designed using the system of the present invention approach.

The Controller

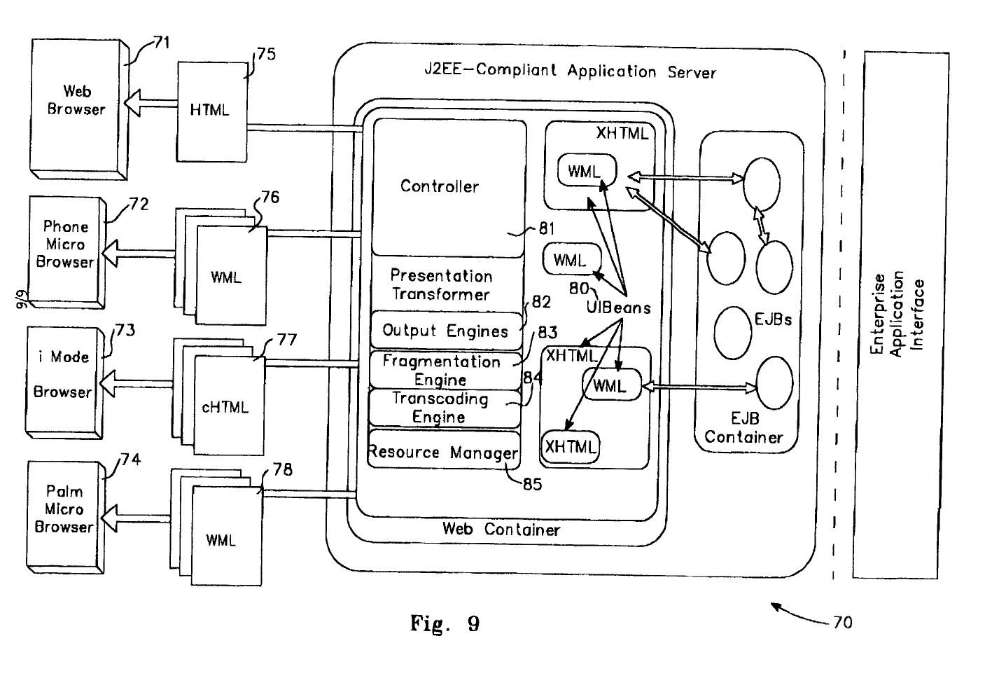

Example 1, as illustrated in block form in FIG. 9 is a thin-client model implementation of the system of the present invention architecture. It assumes that the client will access the content over a request-response mechanism such as HTTP. The Controller runs as a HttpServlet inside a web container and implements the process described earlier in this specification.

The controller uses a ResourceManager, TranscodingEngine, FragmentationEngine and several OutputEngines to implement the entire process.

A UIBean

A UIBean class has been defined, which every UIBean extends. It provides a standard implementation of the method render, which encapsulates the output of the UIBean's paint in a “<mdml.output . . . >” tag. It also provides a eventDispatcher which calls the correct method on the UIBean depending on the HttpRequest passed in by the Controller.

UIBeans can be written in Java or can be written as JSPs. A JspComrpiler class helps compile JSPs into UIBean Java classes.

An MmdlObject

A MdmlObject class provides an implementation of the toString ( ) method in Java, which creates an XML (JOX) representation of the object instance. Thus any object which is created from a class extending MdmlObject can be XMLized by just calling it's toString ( ) function. This automatically happens in JSP, when the object is rendered, thus allowing for the XMLizer notation recommended in the previous chapter.

Transcoding Process

In this example the transcoding process can be a very complex process. However, it is important to the implementation of the system of the present invention architecture and is therefore explained in detail here.

The core of the transcoding process is an algorithm which collapses a mdml.output tree with different formats into a flat document with a single format. The aim of the process is to transcode XML fragments to the format required by the actual access point with as few steps as possible, thus ensuring that the quality of the transcoding is maximized.

Step 1—Determine Target Format

If the format of the top-level mdml.output element is accepted by the target device, it is deemed to be the target format. Otherwise the target format is assumed to be the preferred content format of the target device.

Step 2—Set up Table

A table containing the information from mdml.output elements in the document tree is built. The table contains the format of the output fragment, a reference to the output fragment and the depth of the mdml.output fragment in the mdml-output tree.

Step 3—Clean up Table

The table is scanned for consecutive entries with the same format. If the depth of the first entry is smaller than the depth of the next, it implies that the next entry is inside the earlier one. Under such circumstances, the second entry is removed from the table.

Step 4—Identify Node for Transcoding

Scan through the table and find the node that is the deepest and is not already in the target format. If a transcoder is available from the node's format to the target format, select it. If not, follow the ancestry of this node and identify the shallowest node that has a format for which a transcoder is available. If no transcoder is found, abort process with an error.

Step 5—Transcode

Invoke the transcoder to transcode the mdml.output fragment (a transcoder must retain the encapsulating mdml.output tag in it's output). Rewrite the mdml.output tag to reflect the new format of the document and update the table. Find the ancestor of the transcoded node and find it's format (use target format if this is a top-level node). If the format is same, remove the table entry for the transcoded node.

Step 6—Repeat Steps 4 and 5 until the Table is Empty

This transcoding process ensures that the each fragment goes through as few transcoders as possible. This is expected to improve the quality of the output as there is a potential for some information lose as each transcoding.

For this process to work, a transcoder must copy any mdml.output fragments it encounters in it's source document tree to the output document tree.

Output Filters

At the end of the transcoding process, any output filters defined for the output format are applied. The ouput filter is applied to the final transcoded document before it is passed on for fragmentation. The output filter removes all tags and attributes that are not defined for that device.

URL Translation Procens

A URL translation process needs to be applied to the document to convert all URLs which refer to remote URLs which invoke the correct events from the thin-client browser.

There are 3 types of URLs in a document that need translation before being delivered to the target device. The URLs are tagged using special prefixes, “java:”, “url:” and “nav:”. The “java:” URLs are used to denote method calls in the UIBean that rendered the URL. These URLs are translated by the transcoding engine into HTTP URLs. A general formats of a “java:” URL is shown below.

java:methodName

java:methodName(extraParameters)

The “url:” URLs are available for convenience so that the URLs in an application need not be hard coded to the expected context path. The “url:” portion of the URL is translated to the context path of the current application. Thus a “url:demo/page” would translate to “/context/demo/page”.

The “nav:” URLs are specific to the fragmentation process and are translated by the fragmentation engine. A “nav:prev” URL is translated to a URL which will cause the controller to move back one fragment. A “nav:next” URL is translated to a URL which will cause the controller to move forward one fragment. If it is on the last fragment, it will cause the controller to submit the document.

In addition to translation of special URLs, if a device does not support cookies, URLs need to be encoded with the session identifier. This can be automatically performed by Chameleon thus removing the need to manually encode each URL as recommended in the Java servlet specifications.

All URL translations only happen on tag attributes known to have URL contents. To identify such tag attributes, they have to be defined in the content format definition in the configuration files of Chameleon.

Fragmentation Process

The fragmentation process basically fragments a document if the target device is unable to cope with the document size. The document size is estimated using the metric of the target device, which is a class to help estimate the size of the document delivered to the target device in terms of the limitation of the device (e.g. metric for size in bytes, metric for number of input elements, metric for size in bytes after compression, etc.) . If the document size exceeds the fragment limit specified for the device, the document is fragmented.

Fragmentation honors the MDML tags and therefore only sections marked using mdml.fragment are fragmented. The break-text attribute controls whether text elements in the mdml.fragment section are allowed to be split. mdml.atom sections define atomic areas within a mdml.fragment section that should always be kept together. In addition, atomic-nodes defined in the format definition are also treated as atomic. Documents intended for fragmentation should also provide for navigation buttons. These are rendered conditionally using the mdml.nav tag.

Fragmented documents need to be cached so that the user can navigate through them without having to re-invoke the UIBeans that generated the document. This is handled by the controller. The controller also caches all submitted parameters from different fragments of the document and collates the parameters for single submission to the target UIBean specified using the mdml.submit element.

If parameters are cached, when a new fragment is rendered, the input elements in that fragment need to be initialized with the cached parameter data. This allows for back navigation through forms without having to retype data into fields. This is done during post processing after fragmentation. The input-nodes for every format need to be defined in the format definition in order to accomplish this.

Lastly, the “nav:” URLs need to be rendered correctly as explained before in the previous section.

Savory of Example 1

It provides reusable, stateful, UIBeans with associated output formats. The Presentation Transformer handles requests for presentation from client devices, retrieves the requested UIBeans, and returns presentation logic data in a format acceptable by the client device. Application logic data can be implemented by EJBs (Enterprise Java Beans).

UIBeans/The Useable Guide Components

The UIBeans have the following characteristics:

1. Each UIBean has an associated state.

2. Each UIBean has an associated XML-compliant output format.

3. Each UIBean has event handling mechanisms.

4. UIBeans may be re-used and included within other UIBeans.

XML Support Sub-System

A mechanism is provided to automatically convert data within Java objects into an XML-compliant output format

Presentation Transformer Sub-System

The Presentation Transformer comprises a Controller which uses a Resource Manager, Transcoding Engine, Fragmentation Engine and several Output Engines.

The Presentation Transformer performs the following functions:

1. It is capable of modifying requested UIBeans into a format acceptable by the requesting client device.

2. It is capable of automatically fragmenting UIBeans if the requesting client device is a small-screen device.

3. It is capable of suitably caching presentation content to improve response times.

Development Approach of System

1. Presentation is broken up into suitable smaller logical components or data groupings encapsulating specific presentation logic. Eg. Login, Header, Advertisement, Footer etc.

2. UIBeans are then created to provide the functionality of the identified presentation logic. The creation of UIBeans is based on the display functionality that each of them provides. The UIBeans are not created with specific regard to the output format acceptable by requesting client devices. Since UIBeans are developed with multiple devices in mind they are able to encapsulate presentation logic data common to multiple channels. Eg. A Login component would be common across multiple channels.

3. UIBeans interact with business logic data encapsulated in Enterprise JavaBeans to retrieve desired data.

4. UIBeans are written to output any desired XML-compliant format which becomes its associated output format. The output format of a UIBean need not be in a format necessarily supported by the requesting client device.

5. UIBeans may be mixed and matched and may be embedded within other UIbeans. A UIBean may have an associated output format which is different from the output formats of its embedded UIBeans.

6. The Presentation Transformer Sub-system handles the suitable conversion of UIBeans, and their embedded UIBeans, into a single output format suitable for the requesting client device.

7. If the client device is a small-screen device, the Presentation Transformer Sub-system automatically fragments the requested UIBeans for suitable delivery.

8. The Presentation Transformer Sub-system also suitably caches content to improve response times.

Using the system of the present invention approach, we can design multi-channel applications that have a component based presentation layer which provides presentation reuse across different access points, yet providing the flexibility of very different presentation formats. This reduces the effort required to build and maintain a multi-channel application tremendously, without sacrificing the quality of the presentation on any of the target access points. It also allows new access points to be added after the application has been developed with little effort, even in cases where the new access points were not originally envisioned to be supported.

FIG. 9 illustrates an implementation of the system of the present invention in accordance with the summary described above.

Appendix A provides a full technical specification for an implementation of the system of Example 1. In Appendix A the term “Chameleon” refers to a thin-client model implementation of the architecture of Example 1 and as broadly structured with reference to FIG. 9.

The multi-channel system 70 of FIG. 9 is a thin-client system wherein a plurality of digital interface devices 71, 72, 73, 74 communicate via channels 75, 76, 77, 78 with server 79. The server utilizes reusable guide components 80 to customize at least display portions of information segments in conjunction with the use of sub-systems 82, 83, 84, 85 operating under controller 81 to provide a customized digital data stream for respective devices 71, 72, 73, 74.

Appendix A follows and forms part of this specification.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A design methodology for multi-channel delivery of digital data; said methodology including the step of defining a plurality of reusable guide components; at least some of said components adapted to guide the presentation of a predefined set of data groupings; said data groupings common to more than one digital interface device operating on one or more channels.

2. The design methodology of claim 1 wherein the number of reusable guide components is minimized.

3. A reusable guide component for multi-channel delivery of digital data; said reusable guide component adapted to guide the presentation of a predefined data grouping which is common to more than one digital interface device operating on one or more channels.

4. The reusable guide component of claim 3 wherein said digital data comprises presentation logic data.

5. An environment for implementation of reusable guide components for multi-channel delivery of digital data; said reusable guide components operable in said environment to adapt information segments requested for instantiation on a predefined set of digital interface devices operating on a predefined set of channels whereby said information segments are converted to customized digital data adapted for direct execution on a specified one of said digital interface devices.

6. The environment of claim 5 including one or more functional sub-systems selected from:
(a) A reusable guide component system
(b) A dynamic XML conversion system
(c) A modified mark-up language overlay system
(d) An automatic fragmentation system
(e) A device-aware presentation control system.

7. A modified mark-up language for use as an overlay to a mark-up language representing data including presentation logic data for display on a broadly defined class of digital interface devices operable over a predefined set of channels; said modified mark-up language including tags which define commands for interpretation of said presentation logic data.

8. The language of claim 7 wherein said tags provide a mechanism for controlling how a subset of said presentation logic data is to be presented on said interface device.

9. A mechanism for dynamic conversion of serializable Java objects into XML, said mechanism performing XML conversion by overriding the toString ( ) method of a Java object.

10. A method of processing presentation logic data comprising processing an information segment from which said presentation logic data is to be derived whereby said presentation logic data is segmented into sub-components of lower complexity and whose output can be re-purposed for different ones of a predefined set of digital interface devices operating over a predefined set of channels.
